(19) United States
(12) Patent Application Publication
(10) Pub. No.: US 2004/0169725 A1
(43) Pub. Date: Sep. 2, 2004

(54) Astigmatism tester for reflective concave surfaces

(76) Inventor: John C. Sherman, Northridge, CA (US)

Correspondence Address: John C Sherman, 18015 Rayen St - Guest house, Northridge, CA, 91325, US

(21) Appl. No.: 10/369,018

(22) Filed: Feb. 18, 2003

(51) Int. Cl. H04N 17/00

(52) U.S. Cl. 348/180

(57) ABSTRACT

A device to test reflective concave surfaces, such as telescope mirrors, and refractive convex surfaces for astigmatism, by providing a dot with which to examine an image of a point source which is formed by such surfaces. The dot is preferably held in the light path with a thin piece of optical glass. An additional embodiment has a plurality of dots, also preferably mounted on a piece of glass, with which to examine an optical system. The devices can also be used to test for asphericity of the surface.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to the testing of reflective concave surfaces such as telescope mirrors, and refractive convex surfaces such as objective lenses, and specifically to the equipment used to perform such tests.

2. Prior Art

Telescope mirrors have been called the most accurate macroscopic surfaces ever made by man. Testing such surfaces has always been a challenge. During manufacture it is common to test a mirror from its radius of curvature. Specifically, a light source is used to illuminate the mirror, and the mirror forms an image of the light source which is examined. To keep the light source from obstructing the image, we normally place the source just to one side of the radius of curvature. This forms an image on the other side of the radius of curvature at its conjugate focus. As long as the distance between the conjugate foci is small enough to be negligible, I will refer to the image as being at the radius of curvature.

Early workers used a microscope or an eyepiece at the radius of curvature to examine the image of a pinhole light source. Equivalently, when a telescope is finished it can be aimed at a star and the star's image can be examined at the focal point with an eyepiece. These tests are known as a star test. Using an eyepiece to examine the image of a point source, whether pinhole or star, shows that the image is changed by diffraction. It forms a diffraction pattern. Any aberration in the optical system causes a difference in the observed diffraction pattern. With the star test a comparison is made between the observed pattern and a perfect pattern, and a judgement is made as to what the difference means. Although highly sensitive, this is a somewhat subjective test which does not show aberrations directly, and is not quantitative.

Leon Foucault introduced a knife-edge tester in 1859, which allows quantization of the aberrations discovered in the star test. Variations of the knife-edge tester include a single-wire tester and a Ronchi grating. These are all straight-edge testers. As a result they work only in one dimension, which is perpendicular to the straight-edge.

This can be demonstrated by looking at a mirror in a typical test setup. From the perspective of a person doing a test, the mirror appears flat, as if it is only two dimensional. This is because the person is too far away from the mirror to detect its true three-dimensional shape. The person can then put the chosen straight-edge testing device in the light path and observe the results of motions. If the knife edge or the Ronchi grating is vertically oriented and moved horizontally, its motion is apparent and measurements can be made. If it is moved vertically, the motion is invisible and no measurements can be made. If moved diagonally, only the horizontal portion of the movement is visible. In this manner it is seen that the straight-edge test equipment provides information in only one of the two apparent dimensions. Many users don't realize these devices are limited to one dimension.

The Ronchi grating gives the appearance of operating in two dimensions, but is in reality a one-dimensional tool. A problem with gratings is that they cut the aperture into a number of smaller apertures. Each little aperture has its own diffraction pattern which interferes strongly with the adjacent patterns. There is a tester developed by Mobsby which uses curved lines. However, these lines are designed and used to form straight lines. So the Mobsby grating is also a one-dimensional tool.

Circular gratings, such as a Popov grating, are two dimensional when used with the point light source, but have the same problems with diffraction interference as the Ronchi grating. They cut the aperture of the mirror under test into a number of smaller apertures, and the diffraction effects of each little aperture interferes with the diffraction effects of the other apertures.

A Hartmann test is two dimensional when used with the point light source, but requires painstaking data reduction. This was the test of choice for professionals for many years, but has since fallen out of common use. Very similar to the Hartmann test is a pinhole grid. This test also works, but like the Hartmann test, it suffers from strong diffraction interference effects because of the multitude of tiny apertures.

Interferometry has replaced the Hartmann test for professionals. This two-dimensional test requires expensive auxiliary optics, is difficult to set up, and is difficult to use without error.

A point source/pinhole test is also two dimensional, but is difficult to use. It is very hard to set up, since the user has to look through a tiny pinhole. Furthermore, diffraction from the tiny aperture is severe.

Both the eyepiece and the straight-edge testers can be used with masks to isolate individual zones when working with aspherical mirrors. By testing different zones of the mirror the degree of asphericity can be determined.

The star test works in two dimensions, but is only qualitative. The straight-edge testers are quantitative, but only in one dimension. Therefore the straight-edge testers are nearly helpless in the presence of astigmatism.

Astigmatism is an aberration which occurs in two dimensions. For example a mirror with simple astigmatism can have a different radius of curvature in the vertical diameter than in the horizontal diameter. The star test easily shows astigmatism because it uses a point source of light and an eyepiece. There is nothing to restrain the star test to one dimension. However, the star test only shows a diffraction pattern, and quantitative results are judgemental at best. Straight-edge testers work in only one dimension, so at best they can only detect astigmatism. Astigmatism can be described as a lack of rotational symmetry about the optical axis. To properly see astigmatism in it's entirety a testing scheme has to be able to work in every diameter. So unless properly oriented, a straight-edge tester will not even detect astigmatism. At no orientation can a straight-edge tester see an astigmatism aberration in it's entirety. Measurements of astigmatism with straight-edge testers requires many one-dimensional measurements to be made in different orientations, and then the collected data has to be combined, compared and reduced.

### OBJECTS AND ADVANTAGES

Accordingly, several objects and advantages of the present invention are:

(a) to provide testing equipment which combines the two-dimensional aspect of the star test with the knife-edge tester's ability to provide useful, quantitative measurements;

(b) to provide an easy and inexpensive way to convert straight-edge testing schemes into two dimensions;

(c) to provide an easy and inexpensive way to directly see and define astigmatism;

(d) to provide testing equipment whose use is intuitive to people already familiar with current one-dimensional equipment; and

(e) to provide testing equipment which is less bothered by diffraction than current equipment.

Further objects and advantages are to provide equipment which can be used for other testing purposes, such as measurement of spherical aberration; and to provide equipment which is useful for testing other optical devices, such as refractive lenses. Still further objects and advantages of my invention will become apparent from a consideration of the drawings and ensuing description.

### SUMMARY

In accordance with the present invention an astigmatism tester comprises one or more dots with which to inspect an image of a point light source, such as a pinhole or a star, to determine the quality of the optical system which forms the image.

### DRAWINGS

FIG. 1 shows a perspective view of a single dot on a glass substrate.

FIG. 2 shows a perspective view of a regular grid of dots on a glass substrate.

FIG. 3 shows a view of a test setup in FIG. 5 from the perspective of a person doing a test.

FIG. 4 shows what the person might see when testing an aspherical mirror with the device in FIG. 2.

FIG. 5 shows a side view of a radius of curvature zone of an aspherical mirror.

### DETAILED DESCRIPTION—PREFERRED EMBODIMENT

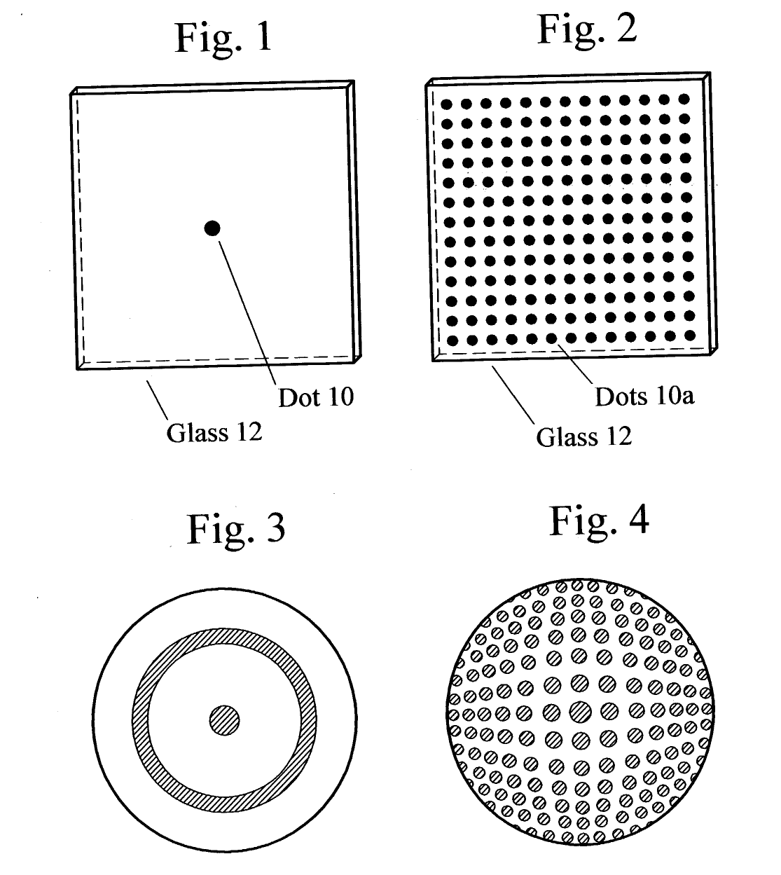

FIG. 1 is a preferred embodiment of the present invention. The embodiment has a round, about 0.01 mm to 0.15 mm diameter, opaque dot or speck 10 mounted on thin optical glass 12. The dot 10 is made from ink or paint which dries onto the glass 12.

Operation—Preferred Embodiment

The preferred embodiment of FIG. 1 is operated by first illuminating a reflective concave surface or mirror under test. A pinhole of about 0.07 mm diameter or less is used to illuminate the mirror from its radius of curvature. The dot 10 is then introduced into the image of the pinhole which is formed by the mirror.

Testing a spherical mirror at its radius of curvature is a null test, meaning every part of the mirror is affected at the same time. The advantage of using my astigmatism tester is that it works in two dimensions, and so astigmatism is immediately and automatically apparent, if it exists to any significant degree. If there is no astigmatism present, the entire image of the mirror will gray out or darken evenly as the dot 10 is brought into the image of the pinhole.

If simple or potato-chip astigmatism is present in an otherwise spherical mirror then a dark line will appear when the dot 10 is inside the mirror's average radius of curvature. This line automatically defines one of the astigmatism axes. It defines the axis with the shorter radius of curvature. And when the dot 10 is then brought to the average radius of curvature of the mirror, there will be an image of the dot 10 which might be square or cross shaped, but does not fill the mirror with it's shadow. So that the mirror as a whole does not darken, or null. When the dot 10 is then brought outside the average radius of curvature there will be another line showing, similar in appearance but perpendicular in orientation to the line observed inside the radius of curvature. This second line defines the axis with the longer radius of curvature. The smaller the dot 10 used in this test, the more sensitive it will be.

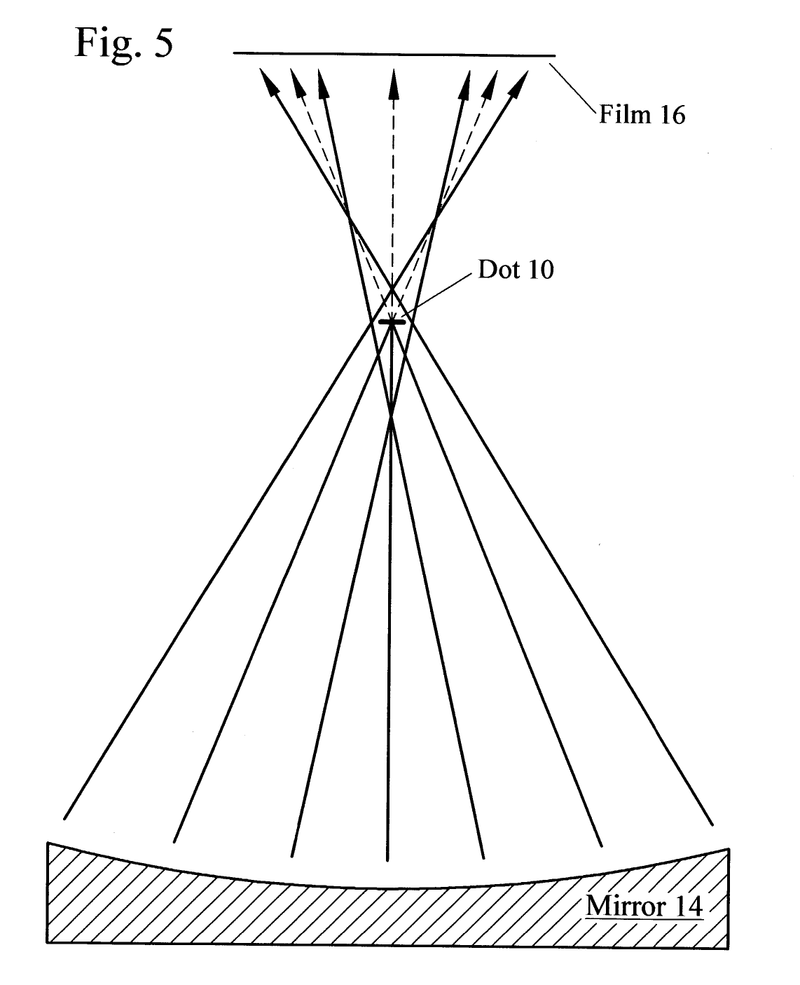

FIG. 5 is a side-view rendering of light rays at the radius of curvature area of an aspherical reflective concave surface or mirror 14. For clarity, the light source and the light rays from the source to the mirror are not shown, but it should be understood that the light source is as close as practicable to the dot 10. Also for clarity the glass 12 which holds the dot 10 is not shown. This test setup can be looked at from the top with a human eye or with a camera. Only a film 16 in the camera is shown. The dot 10 is placed on the optical axis at about the 70% zone. It blocks a light ray at the center of the field of view, shown as a dotted arrow after it is blocked. The dot 10 also blocks the light rays from every part of the mirror 14 which has its light crossing the optical axis at the location of the dot 10. These are also shown as dotted arrows after being blocked. Most of the light passes by the dot 10, shown as solid arrows. In a mirror 14 without astigmatism the zone which has its light blocked will form a shadow which appears as a dark, round ring, as seen in FIG. 3.

If a wire or a knife edge were placed at the 70% zone it would block more light, and the result would also be constrained to one dimension. The dark ring does not form in the same manner, and would not exactly define the part of the mirror 14 with the given radius of curvature. Therefore astigmatism is not necessarily detected. My astigmatism tester would also be constrained to one dimension if a slit light source were used instead of the pinhole specified.

FIG. 3 illustrates what the person testing an aspherical mirror 14 will see if there is no astigmatism. FIG. 3 also illustrates what would be recorded by the film 16 if a camera were to be used. A dark spot in the center of the image corresponds to the center ray in FIG. 5 which is blocked. The dark ring which corresponds to the other blocked rays in FIG. 5 appears perfectly round and centered in the image. The person can move the spot longitudinally along the optical axis to test different zones. This movement will cause the dark ring to get larger or smaller, always exactly representing the zone of the mirror 14 which has its light blocked by the dot 10. In each zone of the mirror 14 an astigmatism-free image will show a perfectly round and centered dark ring.

If my astigmatism tester is used on an aspherical mirror 14 which does have astigmatism, then the dark ring will not be perfectly round. It will show a shape which exactly defines the shape, degree and orientation of the astigmatism aberration. In the case of simple or potato-chip astigmatism the dark ring will form an ellipse. There are a variety of masks in common use which can help a person discern and measure small amounts of astigmatism. For example a four-way ruler, pinstick, or notchstick can be used. Also a modified Couder mask, or a circular zonal mask like that used in 1777 by John Mudge, can all be used in this new test to determine the degree of out-of-roundness of the dark ring. The amount of astigmatism present can be calculated given the shape of the dark ring, and the other parameters of the test such as the diameter and radius of curvature of the mirror.

By using a notchstick, pinstick, or set of masks to isolate individual zones the dot 10 can also be used to determine the asphericity of an aspherical mirror 14. The user first determines that there is no astigmatism in the manner described above. Then the operation and the data reduction of the preferred embodiment when measuring asphericity is identical to that of the knife-edge test and of the wire test as they are commonly used.

Description and Operation—Additional Embodiment

FIG. 2 shows an additional embodiment of my astigmatism tester. The embodiment has a plurality of round, about 0.1 mm diameter, opaque dots or specks 10a mounted on thin optical glass 12. The dots 10a are arranged in a regular grid, pattern, or array and are made from ink or paint which dry onto the glass 12. It is best if the separation between the dots 10a is two or three times the diameter of the dots 10a.

The additional embodiment of FIG. 2 uses a grid of dots 10a inside of or outside of the radius of curvature zone of the mirror, whether it is otherwise spherical or aspherical 14. This embodiment is operated identically to a Ronchi grating as it is commonly used. FIG. 4 shows what the person doing this test on an aspherical mirror 14 might see when there is no astigmatism present. With the Ronchi grating a series of curved vertical lines would be seen, while the same test done with the grid of FIG. 2 shows a series of shadows of the dots following similar curved lines and rows. These dot shadows can be counted in the vertical and the horizontal directions, as well as in different diagonal directions. Because the grid of FIG. 2 works in each direction astigmatism can be easily seen. For example, if there are ten dot shadows vertically but only nine dot shadows horizontally it is immediately obvious that the mirror is not a figure of revolution—it has astigmatism. If there are only eight dot shadows horizontally then it is obvious that the astigmatism is more severe. The degree of severity can then be calculated, given the dimensions of the grid of FIG. 2, the dimensions of the mirror, and the dimensions in the resulting image.

Once the mirror 14 has been determined to be free of astigmatism, the device of FIG. 2 can then be used to determine the degree of sphericity or asphericity of the mirror 14. This can be done in any manner similar to the methods commonly used with Ronchi gratings.

Advantages

Thus the reader should appreciate that my two described embodiments each provide easy and inexpensive equipment for doing quantitative measurements of astigmatism in a mirror, whether the mirror is spherical or aspherical 14. While straight-edge testers can detect the presense of astigmatism only if they are properly oriented, my astigmatism testers will automatically see and define astigmatism at any orientation.

The same equipment can then be used to determine the degree of sphericity or asphericity of the mirror under test. The methods of making and reducing measurements are already well-known and commonly used in one dimension. Since the device of FIG. 2 has a greater clear aperture than the equivalent Ronchi grating, diffraction interference effects are greatly reduced. Also, since the device of FIG. 1 has a greater clear aperture than the equivalent knife edge or wire, diffraction effects are similarly reduced.

The use of the new devices should be intuitive to people already familiar with conventional testing devices and methods. Furthermore, familiar and conventional data-taking and data-reduction techniques can be used.

Conclusions, Ramifications, and Scope

It should be understood that although my astigmatism tester has been described in specific terms of construction, it is not to be construed as limited to those embodiments. Many other variations are possible.

For example the dots 10 and 10a can be larger or smaller than the indicated size. The dots 10 and 10a could in some cases be square or a different shape. The dots 10 and 10a could be in recesses etched or otherwise formed into the glass. Instead of the optical glass 12, the substrate could be a lower quality glass, or even acrylic, plastic, or nearly any other transparent material. The dots 10 and 10a could be spheres moulded or cast into the substrate material. The dot 10 or an equivalent sphere can be suspended by methods other than a substrate material, such as by magnetic fields or acoustic levitation. The dots 10 and 10a can be translucent. The dots 10 and 10a could be marks etched, scratched, drilled or otherwise formed into the substrate. The pinhole light source does not have to be round, or even 0.07 mm in diameter, as long as it is sufficiently small enough to function as a point source. The dots 10a of FIG. 2 can have a random pattern, or be different sizes, or have a pattern similar in function to the Mobsby or the Popov gratings. The dot 10 can also be used at the focal point of a telescope which is pointed at a star to test the entire optical system. The dot grid of FIG. 2 can also be used near the focal point of a telescope which is pointed at a star to test the entire optical system.

The devices and methods I have mentioned can also be used to test convex refractive surfaces by shining the light through the surface. Generally the refractive convex surface will be the first surface of a positive lens being tested, and this means that there will be a second surface in the light path which must be accounted for. Usually one surface is made and tested first, and then the second surface is made and tested. In this manner a single lens or a multi-element group of lenses can be tested as a single unit.

Thus the scope of the invention should be determined by the appended claims and their legal equivalents, rather than by the examples given.

What is claimed is:

1. A device with which to test reflective concave surfaces and refractive convex surfaces for astigmatism and spherical aberration, comprising:
a. a dot, and
b. a means of holding said dot in an image formed by said surface,
whereby said surface may be easily, inexpensively, and quantitatively tested for astigmatism.

2. The device of claim 1, wherein said dot is round, opaque, and sufficiently small enough to examine said image of a point light source formed by said surface.

3. The device of claim 1, wherein said dot is about 0.02 mm to 0.13 mm in diameter.

4. A device with which to test reflective concave surfaces and refractive convex surfaces for astigmatism, comprising:
a. a purality of dots, and
b. a means of holding said dots in a light path formed by said surface,
whereby said surface may be easily, inexpensively, and quantitatively tested for astigmatism.

5. The device of claim 4, wherein said dots are about 0.1 mm in diameter.

6. The device of claim 4, wherein said device is used to test for spherical aberration.

7. A method of testing reflective concave surfaces and refractive convex surfaces for astigmatism and spherical aberration, comprising the steps of:
a. using a point light source to illuminate said surface under test, and
b. providing a dot, and
c. providing a means of holding said dot in an image formed by said surface, and
d. using a means to determine the degree to which an image formed by the system is rotationally symmetric,
whereby said surface may be easily, inexpensively, and quantitatively tested for astigmatism.

8. The method of claim 7, wherein said dot is about 0.02 mm to 0.13 mm in diameter.

9. The method of claim 7, wherein said means to measure astigmatism and spherical aberration may be a camera which makes a photograph of said image which is evaluated later.

10. A method of testing reflective concave surfaces and refractive convex surfaces for astigmatism, comprising the steps of:
a. using a point light source to illuminate said surface under test, and
b. providing a plurality of dots, and
c. providing a means of holding said dots in a light path near an image formed by said surface, and
d. using a means to determine the degree to which said image formed by the system is rotationally symmetric,
whereby said surface may be easily, inexpensively, and quantitatively tested for astigmatism.

11. The method of claim 10, wherein said dots are about 0.1 mm in diameter.

12. The method of claim 10, wherein said means to measure astigmatism may be a camera which makes a photograph of said image which is evaluated later.

13. The method of claim 10, wherein said means to measure astigmatism may also be used to determine the degree of asphericity of said surface.
